(19) United States
(12) Patent Application Publication
(10) Pub. No.: US 2016/0364549 A1
(43) Pub. Date: Dec. 15, 2016

(54) SYSTEM AND METHOD FOR PATIENT BEHAVIOR AND HEALTH MONITORING

(71) Applicants: Baoguo Wei, Salem, NH (US); Ravi Kuppuraj, Andover, MA (US)

(72) Inventors: Baoguo Wei, Salem, NH (US); Ravi Kuppuraj, Andover, MA (US)

(21) Appl. No.: 15/183,503

(22) Filed: Jun. 15, 2016

Related U.S. Application Data
(60) Provisional application No. 62/175,762, filed on Jun. 15, 2015.

(51) Int. Cl. G06F 19/00

(52) U.S. Cl. CPC G06F 19/3481; G06F 19/322; G06F 19/3418

(57) ABSTRACT

System and method for monitoring a patient's health condition is disclosed. The system assesses the patient's health condition based on a data collected by observing the physical activity of the patient and the physical state of the patient. The physical state is measured by vital sign measuring sensors. The patient's health condition is assessed by the system by collectively analyzing the physical activity, the physical state, and a correlation among the acquired data. Further, an authorized personnel issues an intervention to interact with the patient and to validate the assessment of the patient's health condition.

### CROSS-REFERENCE TO RELATED APPLICATIONS

This application is a non-provisional application which claims the benefit to Provisional Application No. 62/175,762 filed on Jun. 15, 2015.

### BACKGROUND

Field of the Invention

The present invention relates generally to monitoring of patient health condition. More particularly, the present invention relates to a system and method for monitoring overall health of the patient and providing intervention based on such monitoring.

Description of Related Art

Monitoring sensor readings and vital signs at patient home of a patient has seen some developments in the recent years. With the improvement generally in the information technology, monitoring of patient relies on data transfer among computerized devices. Blood pressure monitor, blood glucose monitor, blood cholesterol monitor, body weight scale, body temperature measurement device, blood oxygen level, and ECC monitor are some of the examples of patient monitoring devices. These monitoring devices, while provide crucial data of the patient, has their limitation in use.

Using conventional monitoring devices and sensors to monitor a patient is an after-the-fact monitor i.e. monitor patient in acute condition, it is very effective in a hospital in acute condition with 24×7 help from health care providers. On the other hand, the conventional monitoring devices cannot effectively prevent or predict the condition of the patient until a symptom is detected. Thus, the monitoring of a patient with the conventional monitoring devices majorly contributes to identifying the patient's condition once the patient already shows certain symptoms of a disease.

In addition, many conventional monitoring sensors/devices require patient's active action to take a measurement a few times a day. If a patient fails to take the measurement, there will not be any sensor data. This also means the data is not continuously gathered, which leads to an inaccurate and delayed assessment of the patient's health condition.

The data gathered from conventional monitoring sensors/devices of a patient are also generated without collective and comparative analysis of multiple sensor data as a whole. They all individually operate and measure patient, each with a specific singular measurement of the patient's vitals. The diagnosis based on such conventional monitoring of the patient can lead to generalized advices without considering each patients particular physical or psychological properties or progresses. In many cases, doctors consider medical history and trend in diagnosing a patient. In addition, monitoring an interaction between the doctor and the patient can assist in determining an accurate diagnosis of the patient's health monitoring data and symptoms.

In today's health monitoring, the data gathered is not analyzed and being action upon 24×7, data without analysis and proper action does not help a patient. Moreover, today's patient monitoring devices are not customized to patient and are not updated based on changes in patient's health condition. Another issues related to patient monitoring is patient discharge instruction. The discharge instruction is not always read and followed by patient due to how it is presented. Currently, discharge instructions contain to-do list for the patient to follow upon being released from the hospital. It often contains critically health monitoring tasks and warnings that requires the patient to manually follow up with the doctor.

Therefore, there is a need for a monitoring system and associated method that use sensors to monitor a patient continuously with data analysis and proper intervention, including a physician instruction integrated into the intervention. There also is a need for a system that provides multiple communication methodologies between the patient and the doctor for more accurate and continuous diagnosis and intervention based on the patient's condition. What is also needed is a patient's health monitoring system that does not solely relying on the data communication between conventional health monitoring sensors.

### SUMMARY

The subject matter of this application may involve, in some cases, interrelated products, alternative solutions to a particular problem, and/or a plurality of different uses of a single system or article.

In one aspect, a system using a behavior monitoring device and a vital monitoring device for monitoring a patient's health condition is provided. The system may be operatively in connection with one or more processors, a memory, and a data storage unit via a network. The behavior monitoring device may provide a behavior data of the patient acquired by monitoring a physical activity of the patient. The behavior monitoring device may be positioned to monitor the patient and the behavior data may be stored in the data storage unit. The vital monitoring device may provide a physical state of the patient acquired by measuring a vital sign of the patient. The vital monitoring device may be operatively coupled to the patient, and the physical state may be stored in the data storage unit.

The system may further comprise a data aggregation module. The data aggregation module may receive the behavior data and the physical state from the behavior monitoring device and the vital monitoring device, respectively. Further the system may further comprise a multi-parametric analysis module. The multi-parametric analysis module may be configured to compare the behavior data with a model reference, where the model reference provides an expected behavior data. The model reference may be stored in the data storage unit. The multi-parametric analysis module may assess the patient's health condition by collectively analyzing the compared behavior data, the physical state, and a correlation between the behavior data and the physical state. The patient's health condition may indicate a diagnosis of the patient.

In another aspect, a computer implemented method for monitoring a patient's health condition is provided. The method is implemented with a system that uses a behavior monitoring device and a vital monitoring device. The method begins with identifying a behavior data of the patient with the behavior monitoring device. The behavior data may be acquired by monitoring a physical activity of the patient. The behavior monitoring device may be positioned to monitor the patient and the behavior data may be stored in the data storage unit. The method may comprise a step to identify a physical state of the patient with the vital monitoring device. The physical state may be acquired by measuring a vital sign of the patient, where the vital monitoring device is operatively coupled to the patient. The physical state may be stored in the data storage unit.

The method may continue to aggregate the behavior data and the physical state of the patient with a data aggregation module in communication with the one or more processors. A multi-parametric analysis module may compare the behavior data with a model reference. The model reference may provide an expected behavior data. The model reference may be stored in the data storage unit. Further, the method may comprise a step to assess the patient's health condition by collectively analyzing the compared behavior data, the physical state, and a correlation between the behavior data and the physical state, where the patient's health condition indicates a diagnosis of the patient.

### BRIEF DESCRIPTION OF THE DRAWINGS

FIG. 1 provides a block diagram of an embodiment of the system for patient behavior and health monitoring.

FIG. 2 provides an exemplary embodiment of assessing the patient's health condition with the behavior monitoring device.

FIG. 3 provides an exemplary embodiment of assessing the patient's health condition with the behavior monitoring device.

FIG. 4 provides an exemplary embodiment of assessing the patient's health condition with the behavior monitoring device.

FIG. 5 provides an exemplary embodiment of assessing the patient's health condition with the behavior monitoring device.

FIG. 6 provides an exemplary embodiment of assessing the patient's health condition with the behavior monitoring device.

FIG. 7 provides an exemplary embodiment of assessing the patient's health condition with the behavior monitoring device.

FIG. 8 provides an exemplary embodiment of assessing the patient's health condition with the behavior monitoring device.

FIG. 9 provides an exemplary embodiment of assessing the patient's health condition with the behavior monitoring device.

FIG. 10 provides an exemplary block diagram describing the system for patient behavior and health monitoring.

FIG. 11 provides an exemplary embodiment showing data flow path of the system for patient behavior and health monitoring.

FIG. 12 provides an exemplary data acquisition system block diagram of the system for patient behavior and health monitoring.

FIG. 13 provides an exemplary flowchart describing a human validation process for the patient's health condition assessment.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In referring to the description, specific details are set forth in order to provide a thorough understanding of the examples disclosed. In other instances, well-known methods, procedures, components and materials have not been described in detail as not to unnecessarily lengthen the present disclosure.

It should be understood that if an element or part is referred herein as being “on”, “against”, “in communication with”, “connected to”, “attached to”, or “coupled to” another element or part, then it can be directly on, against, in communication with, connected, attached or coupled to the other element or part, or intervening elements or parts may be present. When used, the term “and/or”, includes any and all combinations of one or more of the associated listed items, if so provided.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

Various operations may be described as multiple discrete operations in turn, in a manner that may be helpful in understanding embodiments; however, the order of description should not be construed to imply that these operations are order dependent.

Spatially relative terms, such as “under” “beneath”, “below”, “lower”, “above”, “upper”, “proximal”, “distal”, and the like, may be used herein for ease of description and/or illustration to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable. Such descriptions are merely used to facilitate the discussion and are not intended to restrict the application of disclosed embodiments.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

Some embodiments of the present invention may be practiced on a computer system that includes, in general, one or a plurality of processors for processing information and instructions, RAM, for storing information and instructions, ROM, for storing static information and instructions, a database such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer, controller or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

Generally, the present invention concerns a system and method for patient behavior and health monitoring and providing diagnosis and interventions accordingly. The system and method provides an assessment of the patient's health condition based on a collective analysis of multiple monitoring devices of the patient, environmental factors around the patient, and patient's physical behaviors and behavioral patterns. The system and method for passive patient behavior health monitoring and intervention, disclosed herein, also considers interaction between the patient and an authorized personnel (e.g. doctors, doctors, and nurses) to reach to the diagnosis of the patient, where one or more computerized elements/components of the system communicate with one another in a networked system environment. The authorized personnel contemplated herein may include anybody from patient, health care provider, doctor, to any other monitoring parties having secure authorization.

The system for patient behavior and health monitoring may comprise one or more computers or computerized elements in communication working together to carry out the different functions of the system. The invention contemplated herein further may comprise a data storage unit, such as a non-transitory computer readable media configured to instruct a computer or computers to carry out the steps and functions of the system and method, as described herein. In some embodiments, the communication among the one or more computer or the one or more processors alike, may support a plurality of encryption/decryption methods and mechanisms of various types of data.

The system may comprise a computerized user interface provided in one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any type of computerized interfaces known in the art capable of allowing a user to input data and receive a feedback therefrom. The computerized user interface may further provide outputs executed by the system contemplated herein.

The system for patient behavior and health monitoring, as described herein, may implement a server. The server may be implemented as any of a variety of computing devices, including, for example, a general purpose computing device, multiple networked servers (arranged in cluster or as a server farm), a mainframe, or so forth. The server may be installed, integrated, or operatively associated with the system, which may be configured to determine a patient's health condition. The server may store various data in its database.

In one embodiment, the system for patient behavior and health monitoring may be implemented as a standalone and dedicated device including hardware and installed software, where the hardware is closely matched to the requirements and/or functionality of the software.

In another embodiment, the system for patient behavior and health monitoring may be installed on or integrated with a network appliance configured to establish the network among the components of the system. The system and the network appliance may be capable of operating as or providing an interface to assist exchange of software instructions and data among the components of the system. In some embodiments, the network appliance may be preconfigured or dynamically configured to include the system integrated with other devices.

In yet another embodiment, the system for patient behavior and health monitoring may be installed on or integrated with the server. For example, a multi-parametric analysis module may be integrated with the server or any other computing device connected to the system's network. The server may include the module, which enables the server being introduced to the network appliance, thereby enabling the network appliance to invoke patient behavior and health monitoring as a service. Examples of the network appliance include, but are not limited to, a DSL modem, a wireless access point, a router, a base station, and a gateway having a predetermined computing power and memory capacity sufficient for implementing the components of the system.

In a further embodiment, the system for patient behavior and health monitoring may be installed on or integrated with one or more devices such as a computing device. For example, a smartphone or a tablet with an integrated camera may be implemented in the system to perform the functionalities of the system disclosed herein.

In a further embodiment, the system for patient behavior and health monitoring may be integrated with any number of devices in a distributed fashion.

The system for patient behavior and health monitoring may be implemented in hardware or a suitable combination of hardware and software. In some embodiments, the system may be a hardware device including processor(s) executing machine readable program instructions for analyzing data, and interactions between the components of the system. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor(s) may include, for example, microprocessors, microcomputers, microcontrollers, digital signal processors, central processing units, state machines, logic circuits, and/or any devices that manipulate signals based on operational instructions. Among other capabilities, the processor(s) may be configured to fetch and execute computer readable instructions in a memory associated with the system for performing tasks such as signal coding, data processing input/output processing, power control, and/or other functions. The system may include modules as software units executing on a processor.

The system may include, in whole or in part, a software application working alone or in conjunction with one or more hardware resources. Such software applications may be executed by the processor(s) on different hardware platforms or emulated in a virtual environment. Aspects of the system, disclosed herein, may leverage known, related art, or later developed off-the-shelf software applications. Other embodiments may comprise the system being integrated or in communication with a mobile switching center, network gateway system, Internet access node, application server, IMS core, service node, or some other communication systems, including any combination thereof. In some embodiments, the components of system may be integrated with or implemented as a wearable device including, but not limited to, a fashion accessory (e.g., a wrist band, a ring, etc.), a utility device (a handheld baton, a pen, an umbrella, a watch, etc.), a body clothing, or any combination thereof.

The system may include a variety of known, related art, or later developed interface(s) (not shown), including software interfaces (e.g., an application programming interface, a graphical user interface, etc.); hardware interfaces (e.g., cable connectors, a keyboard, a card reader, a barcode reader, a biometric scanner, an interactive display screen, etc.); or both. The system may operate in communication with a data storage unit and a transmitter.

Data storage unit contemplated herein may be in the format including, but are not limiting to, XML, JSON, CSV, binary, over any connection type: serial, Ethernet, etc. over any protocol: UDP, TCP, and the like.

Computer or computing device contemplated herein may include, but are not limited to, virtual systems, Cloud/remote systems, desktop computers, laptop computers, tablet computers, handheld computers, smart phones and other cellular phones, and similar internet enabled mobile devices, digital cameras, a customized computing device configured to specifically carry out the methods contemplated in this disclosure, and the like.

Network contemplated herein may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or sub-networks, each of which may include, for example, a wired or wireless data pathway. The network may include a circuit-switched voice network, a packet-switched data network, or any other network able to carry electronic communications. Examples include, but are not limited to, Picture Transfer Protocol (PTP) over Internet Protocol (IP), IP over Bluetooth, IP over WiFi, and PTP over IP networks (PTP/IP).

Sensors contemplated herein may monitor patient's vitals, which may include, but are not limited to, Heart Rate, Blood Pressure(s), body weight, concentration of one or more metabolite(s) in the blood, concentration of one or more gas(es) in the blood, temperature, Asystole, Respiration, electrocardiogram. patient vital signs, but not limited to: Respiration, patient activity from accelerometer(s), patient activity from gyroscope(s), ECG beat detection and classification, ECG rhythm classification, ECG interpretation, ECG-ST segment analysis, ECG-QT measurement, Cardiac Output, Heart Rate Variability, Temperature(s), Blood gas (including oxygen) concentration/saturation, metabolite concentration in body fluids.

Sensor, may include, but are not limited to, a sensor circuit detecting a ECG signal(s), a sensor circuit detecting a respiration rate signal indicative of the breathing of the patient and a sensor circuit detecting the movement and/or posture of the patient, such as an accelerometer, 3-axis accelerometer, altimeter, gyroscope, and the like, smell/odor sensors, video/picture sensors, speech/sound sensors, and the like.

The data produced by the sensor may include any type of data, by way of non-limiting examples: a static image derived from but not limited to the following imaging techniques or modalities: optical/photographic, infra-red, magnetic resonance imaging (MRI), ultra-sound imaging, x-ray, computerized tomography (CT), and positron emission tomography (PET). Dynamic images/video derived from but not limited to the following imaging optical/photographic, infra-red, magnetic resonance imaging (MRI), ultra-sound imaging, x-ray, computerized tomography (CT), and positron emission tomography (PET).

Camera contemplated herein may include, but are not limited to, DSLR, non-SLR digital cameras (e.g., but not limited to, compact digicams and SLR-like bridge digital cameras (also known as advanced digital cameras), and SLR-like interchangeable lens digital cameras), as well as video recorders (e.g., but not limited to, camcorders, analog cameras and IP cameras, and the like; a device that can provide a video feed of any duration, such as a DVR; a portable computing device having a camera, such as a tablet computer, laptop computer); and the like.

The video/image data contemplated herein may be any digital image format capable of being interpreted by a computer or a computing device. Examples of image data contemplated herein include, but are not limited to JPEG, GIF, TIFF, PNG, Bitmap, RAW, PNM, WEBP, and the like. Example of video data contemplated herein include, but are not limited to MOV, MP4, AVI, WebM, MKV, FLV, WMV, and the like.

The sound data contemplated herein may be any digital sound format capable of being interpreted by a computer of a computing device. Examples of sound data contemplated herein include, but are not limited to MP3, MP4 AIFF, WAV, and the like.

A system for patient behavior and health monitoring is provided. The system may comprise one or more processors, a memory, a data storage unit, a user (client) device, and user interfaces, all or some of which are place in a networked environment communicating with one another. In particular, the system for patient behavior and health monitoring may comprise a behavior monitoring device, a vital monitoring device, a data aggregation module, and a multi-parametric analysis module. The components of the system may be in communication with one another either directly or indirectly via a network. The vital monitoring device may comprise one or more sensors to measure a physical state of the patient. In some embodiments, vital signs of the patient may be acquired by the vital monitoring device using the one or more sensors.

In some embodiments, the behavior monitoring device may monitor a physical activity of the patient. A behavior data may be generated by the behavior monitoring device as a result of monitoring the physical activity of the patient. Thus, the system comprises two distinguishable devices, the vital monitoring device and the behavior monitoring device, that measure two different aspects of the patient, namely the physical state comprising measurements of vital signs and the behavior data resulting from monitoring the physical activity of the patient.

In some embodiments, the behavior monitoring devices may be attached or be placed within a close proximity to the patient to acquire behavior data of the patient. The behavior monitoring devices may identify the physical activity of the patient and communicate the behavior data to one or more processors. In some embodiments, the behavior monitoring devices may provide passive and continuous patient's activity monitoring to acquire a motion behavior data of the patient by tracking motion/movement of the patient. In some embodiments, the behavior monitoring device may be in communication with the one or more processors to analyze or to run analytics on the identified physical activity of the patient. The results of such analysis and/or the analytics may comprise the behavior data. The analysis of the behavior data may determine a behavioral pattern/trend of the patient.

In some embodiments, the identified physical activity may be compared to a model reference for diagnosing the patient's state. The model reference may be stored in the data storage unit. The model reference may comprise variety of known, expected, and normal response or physical activity of a human being. The model reference may provide an expected behavior data from the patient. Similarly, the model reference may provide a correct behavior data from the patient. In some embodiments, the identified physical activity may be compared to the patient's past data to identify changes, trends, or patterns in the patient's behavior data. Comparing it to the patient's past data may entail whether the patient's state is improving or worsening. In some embodiments, prior to admitting the patient in the system, the physical activity and/or the behavior data may be preconfigured to be referenced as the model reference. As such, an initial patient's behavior data may be recorded to be compared with any following monitoring results of the behavior data. Such feature of the system enables customization and individualization per patient, in order to diagnose the patient's health condition more accurately.

In an exemplary embodiment, the motion behavior data of the patient may be acquired by motion monitoring sensors such as, gyro, 3-axis accelerometer, accelerometers, altimeter, and the like. The motion behavior data may be obtained by observing and measuring the patient's movement as the patient performs an exercise activity or any physical activities. By way of examples, physical activities may include walking, running, cycling, and swimming. The motion monitoring sensors may acquire amount of physical activities performed by the patient by measuring number of steps or its frequency.

In one embodiment, the behavior monitoring device may monitor a sleep activity of the patient. In this embodiment, the behavior monitoring device may acquire sleep behavior data, such as motion, heart rate, and breathing rate and sleep pattern of the patient during sleep. The behavior monitoring device may monitor body movement of the patient while asleep, the time and frequency of the patient leaving the bed, the time and frequency of the patient turning over during sleep, temporary breath stop, temporary heart beat stop, off-bed duration, heart rate, breath rate, and the like. Such monitoring data and/or sensor readings may be analyzed for diagnosing the patient's health condition.

In another embodiment, patient's gait in motion, facial movement during speaking, or other similar activities may be monitored by the behavior monitoring device. Similarly, patient's speech pattern and voice during speaking or other similar activities may be monitored by the behavior monitoring devices. For example, the behavior monitoring device may include a microphone or other similar devices to record sound. These data can often times provide certain symptoms of a certain disease. By way of an example, slurring of speech often is a symptom of a stroke. While the vital signs of the patient may be normal, identifying such behavior abnormalities of the patient's physical activity can pre-diagnose or more accurately diagnose the patient's state, thereby providing an opportunity to prevent any possible tragedies.

In yet another embodiment, the behavior monitoring devices may monitor patient's skin tone and complexion. This may be done by observing the patient with a video/picture capturing device taking video/image of the patient. In some embodiments, patient's facial expressions and body languages may be observed which may provide indications of stress, fatigue, and the like of the patient.

In a further embodiment, the behavior monitoring device may monitor odor or smell of the patient with chemical/smell/odor sensors. The smell or odor of the patient may be measured from body parts and breath. By way of an example, the behavior monitoring device may identify certain chemical compounds, such as urea, from the urine of the patient for further analysis of the patient's state.

In a further embodiment, the behavior monitoring device may be a camera. The camera may be utilized to track movement/motion, sleep activity, skin tone, facial activity, gait, body language, and the like.

The behavior data gathered by the behavior monitoring device may be analyzed by the one or more processors. The behavior data gathered by the behavior monitoring devices also may be stored by the data storage unit. The behavior data gathered by monitoring the patient may be analyzed to provide a health score summarizing the condition of the patient.

The system may further comprise vital monitoring devices. The vital monitoring devices also may be positioned or attached to the patient to monitor the health condition of the patient. The vital monitoring devices may measure the patient's vital signs to acquire the physical state of the patient. In one embodiment, the types and number of the vital monitoring devices may be personalized to meet the patient's medical condition, the patient's preference, and/or the patient's progress in comparison to the past data. The allocation of the vital monitoring devices may be based on diseases or medical history of the patient.

Certain combination of the vital monitoring devices may be provided to the patient for collective analysis of multiple vital monitoring devices. In some embodiments, the physical state of the patient may be acquired by the vital monitoring device using the one or more sensors. Examples of the vital monitoring devices may include, but not limited to, vital sign sensors to measure patient's blood pressure (BP), blood oxygen saturation (SPO2), EKG, blood sugar level, body temperature, and the like.

In some embodiments, the system for patient behavior and health monitoring may further comprise an environment sensor. The environment sensor may measure environmental condition surrounding the patient, such as ambient temperature, humidity, and UV index.

In some embodiments, the system for patient behavior and health monitoring may further comprise a patient device. The patient device may be a stand-alone device that provides a computerized user interface for the patient to interact with the system. The patient device may require patient's interaction to obtain certain measurements from the patient. The patient device may be of any types of computing devices.

In some embodiments, the vital monitoring device itself may require the patient's interaction with the device for a measurement. By way of example, these vital monitoring device types may include weight scale, body fluid analysis sensors, and the like.

The sensors may be updated and calibrated based on the health condition of the patient. In some embodiments, some or all of the sensors may not be necessary when the patient's health condition improves. Similarly, additional sensors may need to be placed or replaced when new symptoms or health conditions arises. In other embodiments, the sensors may require calibration based on the health condition of the patient. The system, in communication with the sensors, may update, activate, deactivate, calibrate, or recalibrate the sensors accordingly. The type of the vital monitoring devices and its sensors, and/or the behavior monitoring device may be selected based on the patient's initial state, the past data, and the progress the patient makes over time.

The behavior data from the behavior monitoring device and the physical state from the vital monitoring device may be acquired and stored in the data storage unit. In addition, these data gathered by the monitoring devices may instantly analyzed and provide diagnosis to the patient. In one embodiment, the devices may passively and continuously monitor the patient without requiring any patient interaction with the system. The data may be recorded minute-by-minute or second-by-second to the data storage unit. In another embodiment, the data resulting from monitoring the patient may be periodically collected. Details in utilization and analysis of the sensors data is provided in the following paragraphs.

The data acquired by the monitoring devices may be accessible to a limited amount of personnel, such as a designated health care provider. The system may allow the patient to be monitored by the designated health care provider. Such limited personnel may be referred to as an authorized personnel.

A client device may be provided to the patient (the patient device) and/or the authorize personnel to establish a communication between the two parties. The client device may be a computing device in communication with the network. The client device may provide a computerized user interface to receive inputs from the patients/authorized personnel and/or provide output generated by the system. In some embodiments, the client device may generate patient generated data to the system via the computerized user interface. The patient may interact with the system to take patient surveys, instructions, exercises, or questionnaires provided by the authorized personnel using the client device. The client device may be utilized to facilitate the interaction between the patient and the patient device, in turn the interaction between the patient and the authorized personnel. In some embodiments, the behavior monitoring device may monitor such interaction to generate the behavior data. The physical activity resulting from such interactions may be identified by the behavior monitoring device itself. Similarly, the physical activity resulting from such interactions may be identified by the client device/the patient device as well. In some embodiments, the accuracy and/or the response time of the patient complying with such interactions may be monitored. As such, the client device may be utilized in order to assess the patient's health condition. In some embodiments, the authorized personnel may use the client device to provide interventions, diagnosis, patient surveys, instructions, exercises, or questionnaires to the patient device.

The client device or the patient device may be in communication with the behavior monitoring device and the vital monitoring device. The monitoring data acquired by the devices may be transmitted to the system for continuous sensor calibration and updates. The monitoring data may feedback to the system and update the intervention protocol or other diagnosis protocol stored in the data storage unit. By way of example, this ensures continuous patient care beyond hospital discharge, and allows active and effective monitoring of the patient post discharge.

The intervention administered by the doctor may require inputs, responses, and the like from the patient for a diagnosis of the patient. In these cases, the doctor may provide interventions through the system to the computerized user interface of the patient's client device. Patient interaction may weigh into the diagnosis of the patient's health condition in light of the sensor readings. The types of data communicated between the authorized personnel's client device and the patient device may be of any appropriate data types to facilitate the functions of the present system.

In some embodiment, the client device may be a portal for the authorized personnel to communicate and provide intervention to the patient. The authorized personnel may be utilizing a client device on the authorized personnel's end to communicate with the patient's client device via the networked system environment. Such communication channel may be utilized for the authorized personnel to provide teleconsulting to the patient. The client device may comprise camera, microphone, and a speaker to establish video and audio data communication between the multiple client devices.

In some embodiment, the doctor may utilize the client device to monitor the physical state and the behavior data instantly while in communication with the patient. The doctors or the authorized personnel may request to calibrate, add, remove, replace, and update the monitoring devices of the system. The authorized personnel may a review the acquired data from the monitoring devices to further verify or validate the assessed patient's health condition.

The system for patient behavior and health monitoring may further comprise a data aggregation module in communication with the one or more processors and the data storage unit. The data aggregation module may receive data generated by the behavior monitoring device and the vital monitoring device. Further, the data aggregation module may receive patient generated data from the client device. The data aggregation module may collect all the received data for further analysis.

The system may further comprise a multi-parametric analysis module. The multi-parametric analysis module may be in communication with the one or more processors and further in communication with other components of the system via the networked system environment. The multi-parametric analysis module may examine the behavior data, the physical state, and the patient generated data from the behavior monitoring device, the vital monitoring device, and the client device, respectively, and generate a health status score. The health status score may then be transmitted to the doctor's client device for further actions, including interventions. The health status score may indicated the patient's health condition. The multi-parametric analysis module may collectively analyze the received data from the behavior monitoring device, the vital monitoring device, and the client device, in any combination thereof. The multi-parametric analysis module may identify correlations or causal relations among the received data and/or its trend/pattern over time.

In some embodiments, the multi-parametric analysis module may individually compare the received data with each of its threshold, to identify any abnormalities. In some embodiments, the multi-parametric analysis module may collectively compare the received data to generate the health status score that reflects multiple sensor data and any patient generated data. The threshold may be predetermined and stored at the data storage unit.

In some embodiments, the multi-parametric analysis module may generate the health status score based on the trend of the received data over time. In some embodiments, the health status score may reflect the medical history of the patient, looking for any improvements or decline in the patient's relative health condition.

In some embodiments, the multi-parametric analysis module may compare the data acquired from the behavior monitoring device, the vital monitoring device, and the client device to the model reference discussed above. In some embodiments, the data storage unit may store a preconfigured scenario or a protocol for the collective analysis of the received data. Such preconfigured scenario may include logics that define the patient's health condition based on certain combinations of the behavior data and the physical state measured respectively by the behavior monitoring device and the vital monitoring device. The preconfigured scenario may include logics that define the patient's health condition based on certain order of occurrence in the behavior data and the physical state acquired. Additionally, the preconfigured scenario may include logics that define the patient's health condition based on a trend of the behavior data and the physical state measured over time. The preconfigured scenario may be updated, calibrated, customized, or individualized per patient's progress, medical condition, and the like. It may be constantly updated each time the data is received by the system. Based on the analysis performed by the multi-parametric analysis module, the patient's state/health condition status may be updated.

In some embodiments, an intervention protocol and a diagnosis protocol may be governed by the multi-parametric analysis module. The multi-parametric analysis module may provide a diagnosis and/or an intervention based on its analysis. Such diagnosis and intervention may be stored in the data storage unit. The intervention protocol and the diagnosis protocol may define the intervention and/or the diagnosis suitable for various possible analyses by the multi-parametric analysis module.

In some embodiments, the data received from the behavior monitoring device and the vital monitoring device may be utilized to verify the patient's state observed by each of the devices. The patient's health condition assessed by the multi-parametric analysis module may be based on the physical state acquired by the vital monitoring device and the behavior data acquired by the behavior monitoring device. The physical state and the behavior data may be compared to verify any health condition assessments resulting from each of the devices. For example, certain behavior data may be expected in line with a certain physical state, and vice versa. In some embodiments, a human validation step may be performed by transmitting the data received from the behavior monitoring device and the vital monitoring device to the authorized personnel. The authorized personnel, most likely a doctor, may review the acquired data to verify or validate the patient's health condition assessment, the intervention, and/or the diagnosis. The authorized personnel's client device may be used to transmit a human validation response to the multi-parametric analysis module.

By way of an example, the patient health status score may be generated from 1 to 100, where 1 indicates patient is at the worst condition and requires immediate medical intervention, while a score of 100 indicates the patient is in excellent health condition. Once the multi-parametric analysis module indicates 1 as the health status score, the intervention module may send an alert to the patient's client device, requesting the patient's interaction with the client device. In the meantime, the alert may also be sent to the doctor's client device. If the intervention module could not get any feedback from patient, a warning and/or messages may be issued to the doctor's client device together with the patient's health status score and dashboard of the data observed will be generated regularly (for example every 3 second for a hour).

When the score is closer to 100, the intervention module may send an encourage message (with award) to the patient. When, the patient's health status score is 80, the intervention module may request the patient to run a survey on the client device, the survey may consist of questions and an interaction sessions by the patient via the client device. The patient's client device may record the survey result and the patient's interaction sessions with audio and/or video recordings.

Depending on the health status score of the patient, certain protocols, including medical protocols, may be recommended by the system and sent to the patient's client device. The doctor may interactively monitor and issue certain feedback or intervention to the patient depending on the health status score.

The system for patient behavior and health monitoring may further comprise an intervention module. The intervention module may be in communication with the one or more processors. The intervention module may provide the intervention to the patient based on the analysis performed by the multi-parametric analysis module. The intervention module may be configured to: 1) generate an alert based on the health status score, where the health status score is compared to a predetermined value to generate the alert; 2) generate actionable message to the patient via the client device; 3) provide diagnosis as a result of the multi-parametric analysis module; and 4) generate a channel for the doctor to intervene/communicate with the patient's client device. The alert may be generated in different forms, which may include, but not limited to, visual message, text message, audible message, and the like.

By way of examples, the intervention module may provide instructions, feedbacks, video instructions, video consultation, tele-consultation, hospital discharge instructions, doctor office visits and hospital admission, and the like. The intervention module may allow interaction between the doctor's client device and the system, which allows the doctor to monitor the patient, the patient's response and provide a channel to interact with the patient to diagnose the patient's health condition.

The system may further comprise an identification module in communication with the one or more processors. The identification module may receive and identify the patient's identity. In one embodiment, the identification module may require the patient to comply with certain instruction to confirm the patient's identity. The client device may be utilized for the patient to access the system and to access the identification module. In some embodiment, the instruction may require the patient to provide physical movements. Once the patient follows the instructed physical movements successfully, the patient may be able to access the system via the client device.

The identification module may also instruct the patient to produce certain audible elements for speech analysis. The data received by the identification module may be utilized to further monitor the patient's health condition.

The system may further comprise a location tracking unit. The location tracking unit may be in communication with the one or more processors. The location tracking unit may detect the patient's geographical location. Such location tracking unit may include, but not limited to GPS unit and the like. The location identified by the location tracking unit may then be utilized to provide the system with data specific to the location, such as environmental conditions, seasonal ailment trend, and outbreaks.

The system may further comprise a report generator configured to generate a report, to either the patient or the doctor, based on the sensor data, patient generated data, the analysis module, the intervention module, and the identification module.

By way of an example, when a patient is being discharged from a hospital, in a week before patient leaves the hospital, base patient data will be collected, the data includes activity and sleep pattern, base audio and video recordings, as well as other vital sign data. At discharge, doctors will put post hospital care plan into the system which includes prescription, nutrition, exercise etc. The patient will be given a monitoring kit include a client device, activity and sleep monitor and optionally vital sign monitors. Once the patient is at home, physical activities and sleep data, environment (smell, temperature, etc.) will be passively monitored, and some audio and video data will be randomly recorded. The system will interact daily with the patient to receive feedback, provide alert and instructions as part of the intervention. The patient may receive certain message via the client device, for example, “hello” to the patient with positive feedback such as “you did great yesterday”, “you walked 1000 steps”, “you had a good sleep” or it could be some alerts such as “you had not taken your pressure reading for a while, please take one shortly” or an instruction asking the patient to take an audio and video sessions. A manual intervention may be provided by the doctor, this could be a nurse/doctor video visit or an office visit which may lead to change in post hospital care plan.

By way of another example, when a CHF patient is being discharged from a hospital, the patient gets a monitoring kit including the client device, activity and sleep monitor and a weight scale. Patient information and doctors discharge instruction are synced to the client device before the patient is discharged from the hospital. Once the patient is at home, the patient's physical activities, sleep and weight scale data will be collected by the sensors continuously and synced to the system, the data will be uploaded to the data storage unit, and the multi-parametric analysis module may provide the health status score to the intervention module which will is accessible by the doctor's client device.

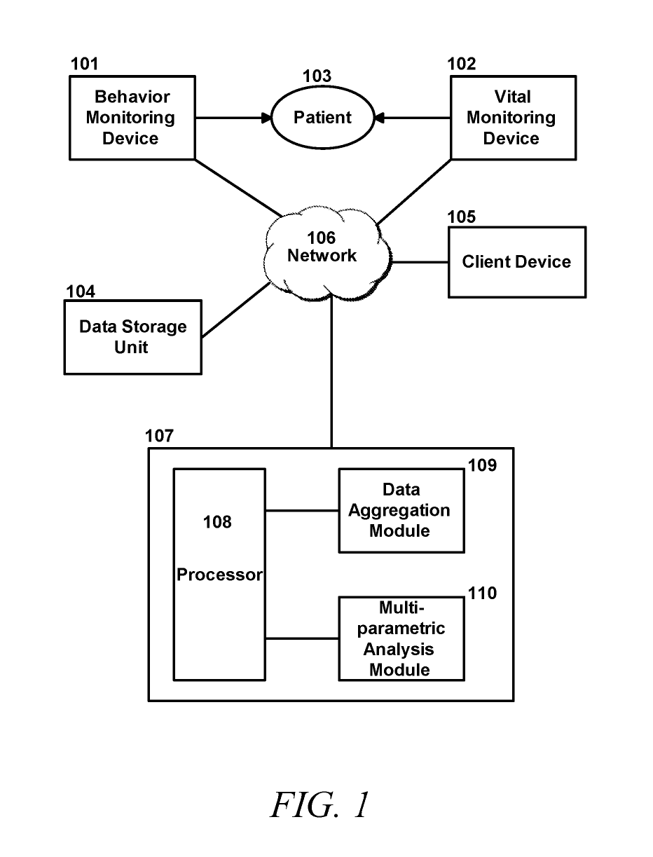

FIG. 1 illustrates a block diagram of an embodiment of the system for patient behavior and health monitoring. The system may comprise the behavior monitoring device 101, the vital monitoring device 102, the data storage unit 104, the client device 105, and a server 107 for processing data. The components of the system may be in communication with one another, in direct/indirect connection via the network 106. The behavior monitoring device 101 and the vital monitoring device 102 may be positioned to monitor the patient 103. The behavior monitoring device 101 may monitor the physical activity of the patient 103 and provide the behavior data as a result. Similarly, the vital monitoring device 102 may monitor the vital signs of the patient 103 by measuring the patient 103 with a variety of sensors described above. The monitoring data acquired by the vital monitoring device 102 may provide the physical state as a result. The behavior data and the physical state may be stored in the data storage unit 104. The system may further comprise the client device 105. The server 107 may comprise the data aggregation module 109 and the multi-parametric analysis module 110 operated by the processor 108. The data aggregation module 109 gathers the data acquired by the behavior monitoring device 101 and the vital monitoring device 102. The multi-parametric analysis module 110 collectively analyzes the behavior data, the physical state, and a correlation between the behavior data and the physical state in order to assess the patient's health condition.

In some embodiments, the multi-parametric analysis module 110 may further compare the behavior data with a model reference. The model reference may be an expected data from the patient, for example an expected physical motion/movement from the patient, an expected response from the patient upon certain instruction requested by the system, and an expected gait pattern of the patient. The model reference also may be a past data of the patient gathered over time. The trend of the past data of the patient may be compared with the instant behavior data acquired by the behavior monitoring device 101. The model reference may be an initial state of the patient. For example, the patient initial skin tone. Additionally, the model reference may be a preconfigured medical data that entails a normal state of the patient. Once compared, the multi-parametric analysis module 110 may further consider the comparison in determining the patient's health condition.

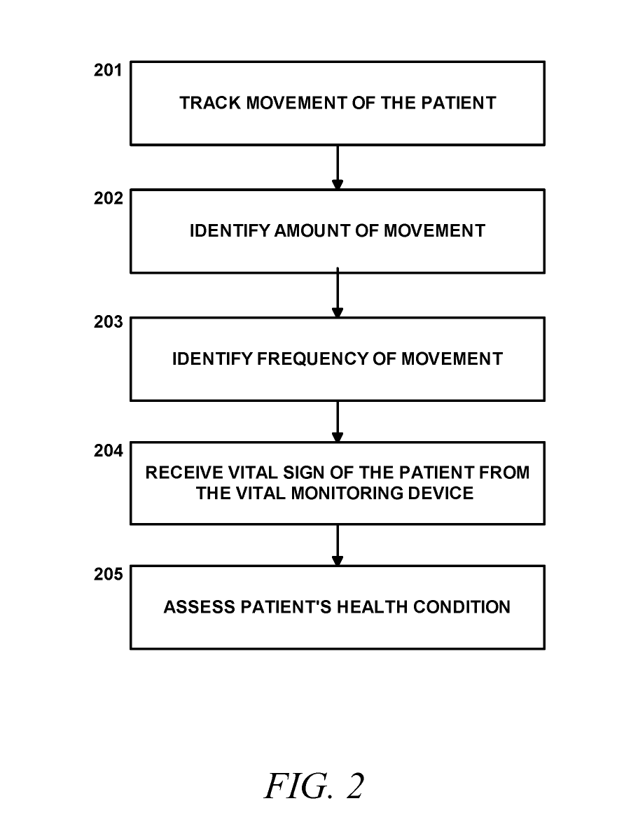

FIGS. 2 through 9 describe exemplary embodiments of assessing the patient's health condition with the behavior monitoring device. The behavior data acquired from the behavior monitoring device may be individually compared to the model reference by the multi-parametric analysis module. In addition, the behavior data may be collectively analyzed with the physical state acquired from the vital monitoring device by the multi-parametric analysis module. The patient's health condition may be assessed by, in any combination, analyzing the trend of the monitored data over time, correlation among the data, causality among the data, and the human validation response overviewing the monitored data by the authorized personnel. Further, the multi-parametric analysis module may include the comparison of the behavior data in its analysis. In general, the model reference may provide a comparable reference to analyze the behavior data acquired by the behavior monitoring device.

In one embodiment, the model reference may be a known or an expected data. The physical activity monitored by the behavior monitoring device may be expected to be in a certain status. For example, a certain physical response may be expected after taking a prescribed medicine. In another example, a certain physical reaction from the patient may be expected. In yet another example, a certain change in the patient's physical activity may be expected.

In another embodiment, the model reference may be a medically correct response from the patient. Similarly, the model reference may be a correct action from the patient in response to a certain instruction or interaction provided by the authorized personnel.

In yet another embodiment, the model reference may be the behavior data acquired from the patient in the past prior to the instant behavior data. Certain trends or changes in the behavior data may be identified by comparing the instant behavior data with the past data. Similarly, the model reference may be the initial patient's state. Prior to applying any treatments to the patient, the initial reaction, response, motion, or any physical pattern of the patient may be recorded to be used as the model reference.

FIG. 2 illustrates a process of assessing the patient's health condition by tracking the movement of the patient with the behavior monitoring device. The motion monitoring sensors may be utilized. The movement of the patient is tracked 201. Then, the amount of the movement and the frequency of the movement is identified by the system at steps 202 and 203. The vital signs of the patient is received from the vital monitoring device 204. Finally, the patient's health condition is assessed at step 205 based on the tracked movement and the vital signs of the patient. The patient's health condition may be assessed by, in any combination, analyzing the trend of the monitored data over time, correlation among the data, causality among the data, and the human validation response overviewing the monitored data by the authorized personnel. Further, the amount of movement and the frequency of movement (how often the patient performs a certain movement) may be compared with the model reference. The model reference may be an expected movement, an expected amount of movement, and an expected frequency of movement.

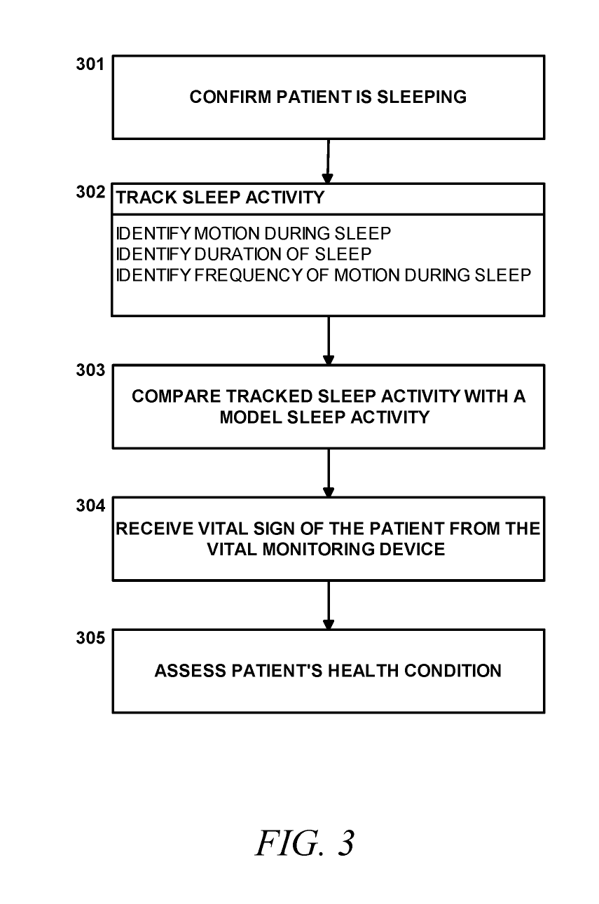

FIG. 3 illustrates a process of assessing the patient's health condition by monitoring the patient's sleep activity. The system initially confirms the patient is asleep at step 301. The behavior monitoring device may track the sleep activity of the patient at 302. The monitoring of the sleep activity may comprise identifying motion during sleep, duration of sleep, and frequency of motion during sleep. The tracked sleep activity may be compared with a model sleep activity 303. The vital sign of the patient is received from the vital monitoring device at 304. An assessment of the patient's health condition is provided at 305 by the multi-parametric analysis module. In the step of comparing with the model sleep activity, the sleep activity tracked by the behavior monitoring device may be compared with an expected trend, past data, and the patient's initial state, as further described above.

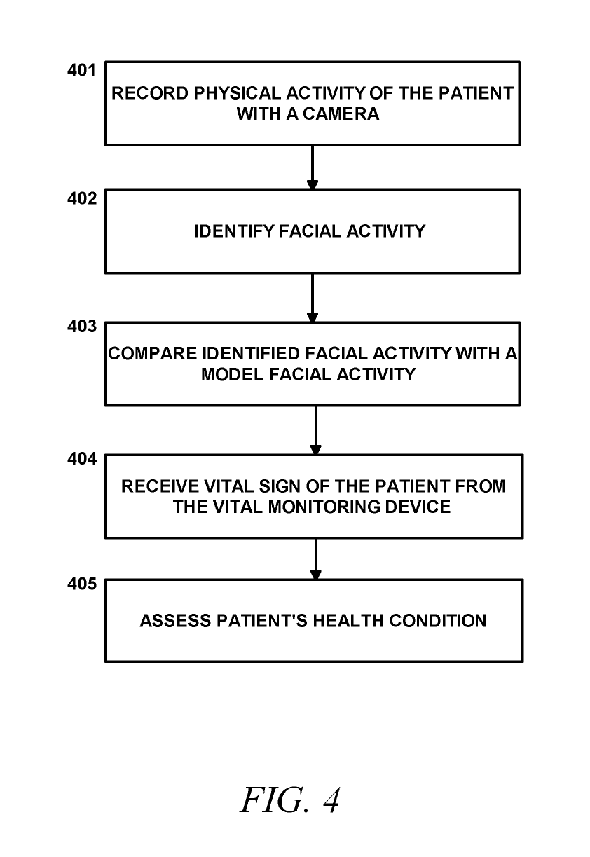

FIG. 4 illustrates a process of assessing the patient's health condition by monitoring the patient's facial activity with a camera. The behavior monitoring device may be the camera. The camera records the physical activity of the patient 401 to gather the behavior data. The facial activity of the patient is identified by the behavior monitoring device at step 402. The identified facial activity may be compared with a model facial activity 403. The vital sign of the patient is received from the vital monitoring device at 404. An assessment of the patient's health condition is provided at 405 by the multi-parametric analysis module. The identified facial activity at 402 may be compared with an expected facial activity stored in the data storage unit. In some embodiments, the identified facial activity at 402 may be a response by the patient to a certain action. The facial activity as a response may be expected to be in a certain manner.

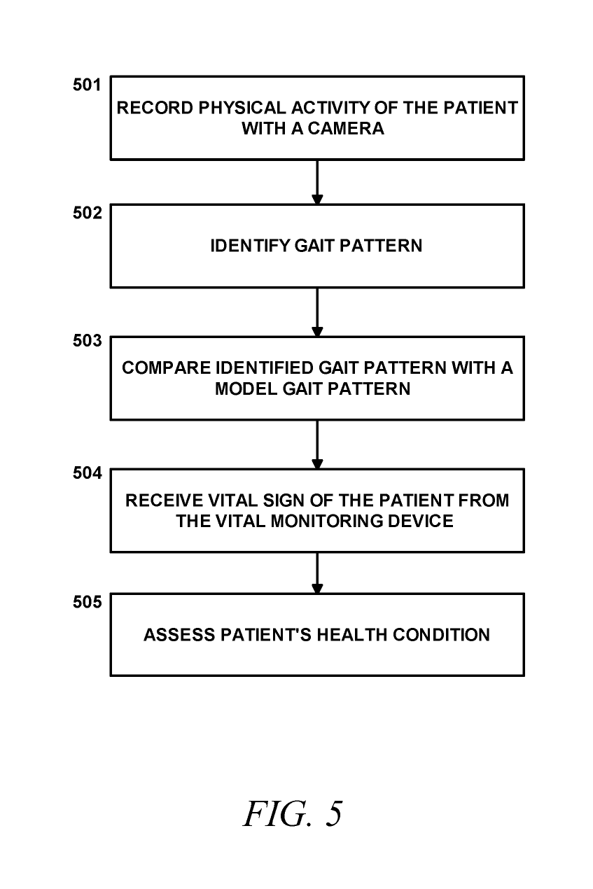

FIG. 5 illustrates a process of assessing the patient's health condition by monitoring the patient's gait pattern with a camera. The behavior monitoring device may be the camera. The camera records the physical activity of the patient 501 to gather the behavior data. The gait pattern of the patient is identified by the behavior monitoring device at step 502. The identified gait pattern may be compared with a model gait pattern at 503. The vital sign of the patient is received from the vital monitoring device at 504. An assessment of the patient's health condition is provided at 505 by the multi-parametric analysis module. In the step of comparing with the model gait pattern, the identified gait pattern may be compared with an expected trend, past data, and the patient's initial state, as further described above. For example, monitoring of the gait pattern can identify a progress in patient's physical therapy.

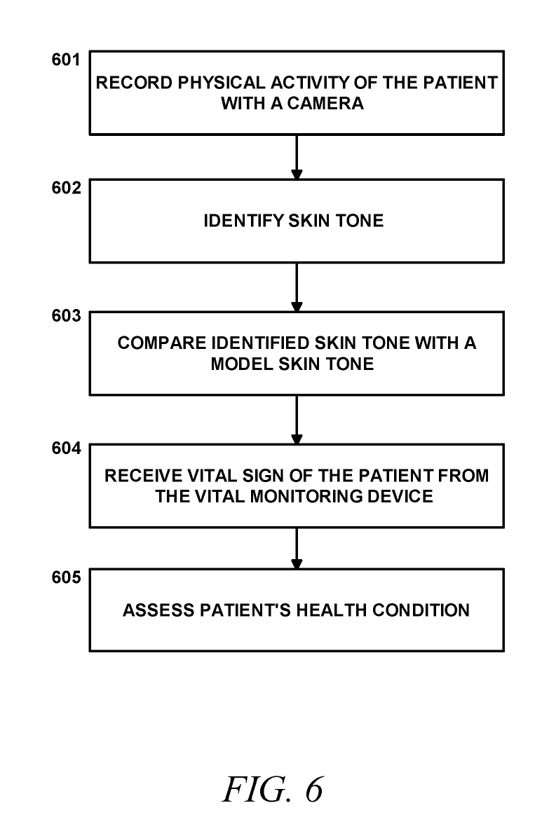

FIG. 6 illustrates a process of assessing the patient's health condition by monitoring the patient's skin tone with a camera. The behavior monitoring device may be the camera. The camera records the physical activity of the patient 601 to gather the behavior data. The skin tone of the patient is identified by the behavior monitoring device at step 602. The identified skin tone may be compared with a model skin tone 603 stored in the data storage unit. The vital sign of the patient is received from the vital monitoring device at 604. An assessment of the patient's health condition is provided at 605 by the multi-parametric analysis module. The identified skin tone at 602 may be compared with an expected skin tone or color stored in the data storage unit. It also may be compared with a past data and the patient's initial state, as further described above.

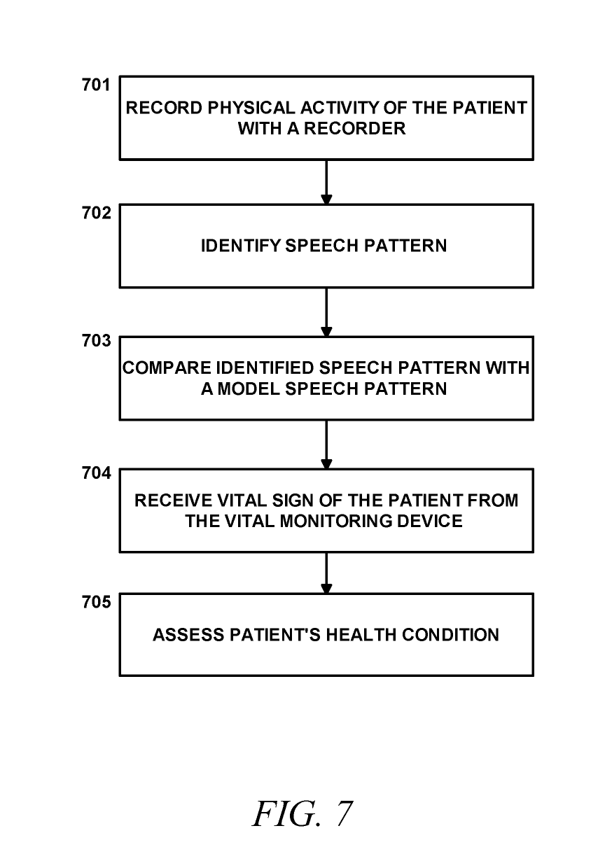

FIG. 7 illustrates a process of assessing the patient's health condition by monitoring the patient's speech pattern with a recorder. The behavior monitoring device may be the recorder. The recorder records the physical activity (sound, speech, and the like) of the patient 701 to gather the behavior data. The speech pattern of the patient is identified by the behavior monitoring device at step 702. The identified speech pattern may be compared with a model speech pattern 703 stored in the data storage unit. The vital sign of the patient is received from the vital monitoring device at 704. An assessment of the patient's health condition is provided at 705 by the multi-parametric analysis module. The identified speech pattern at 702 may be compared with an expected speech pattern or past data stored in the data storage unit. It also may be compared with the patient's initial state, as further described above. The speech pattern may include voice tone, sound, pronunciation, pitch, vibration, and the like from the patient.

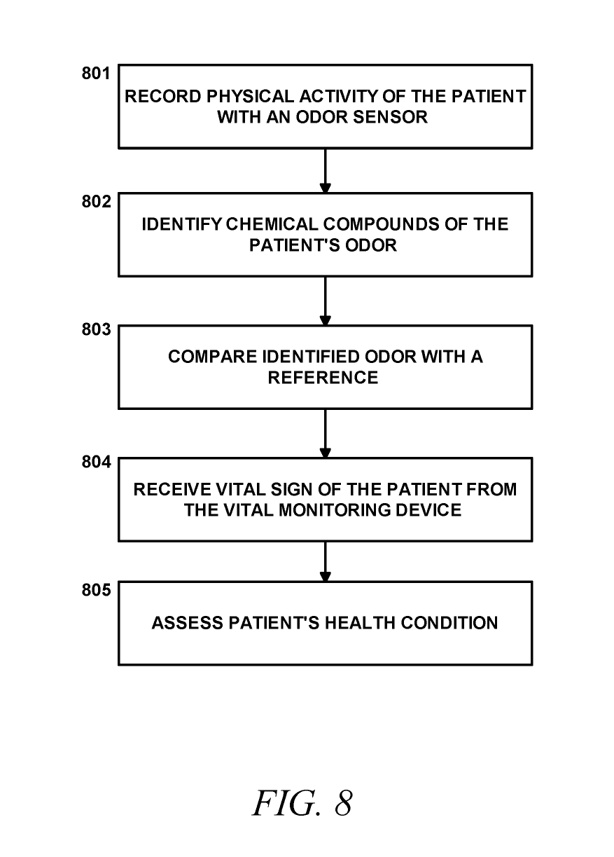

FIG. 8 illustrates a process of assessing the patient's health condition by monitoring the patient's odor with an odor sensor. The behavior monitoring device may be the odor sensor. The odor sensor detects the physical activity of the patient 801 to gather the behavior data. The chemical compounds of the patient's odor is identified by the behavior monitoring device at step 802. The identified odor may be compared with a model reference at step 803 stored in the data storage unit. The vital sign of the patient is received from the vital monitoring device at 804. An assessment of the patient's health condition is provided at step 805 by the multi-parametric analysis module. The identified chemical compounds of the odor may be compared with a known chemical compound of an odor, in order to assist in assessing the patient's health condition. It also may be compared with a past data and the patient's initial state, as further described above.

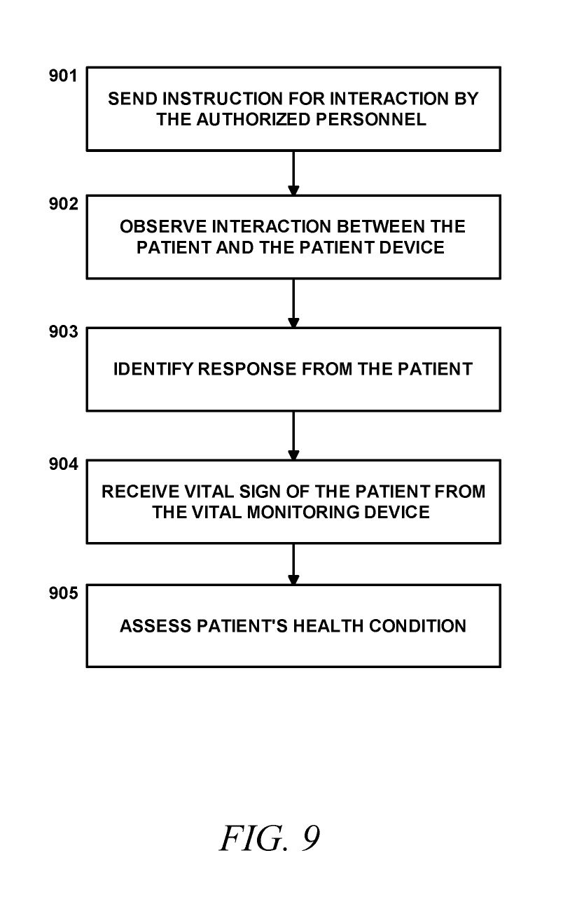

FIG. 9 illustrates a process of assessing the patient's health condition by observing the interaction between the patient and the patient device by the behavior monitoring device. First, the authorized personnel may send an instruction to the patient device requesting a certain interaction to be performed by the patient at step 901. The interaction of the patient is observed at step 902. At step 903, the behavior monitoring device identifies a response from the patient. The response may be a physical activity including, movement/motion, speech, facial activity, body language, text, and the like. One or more of the behavior monitoring device types described herein may be utilized. The vital signs of the patient is received from the vital monitoring device at step 904. Finally, the patient's health condition is assessed at step 905 based on the response and the vital signs of the patient by the multi-parametric analysis module. The response may be evaluated to identify its accuracy or to be compared with an expected response stored in the data storage unit.

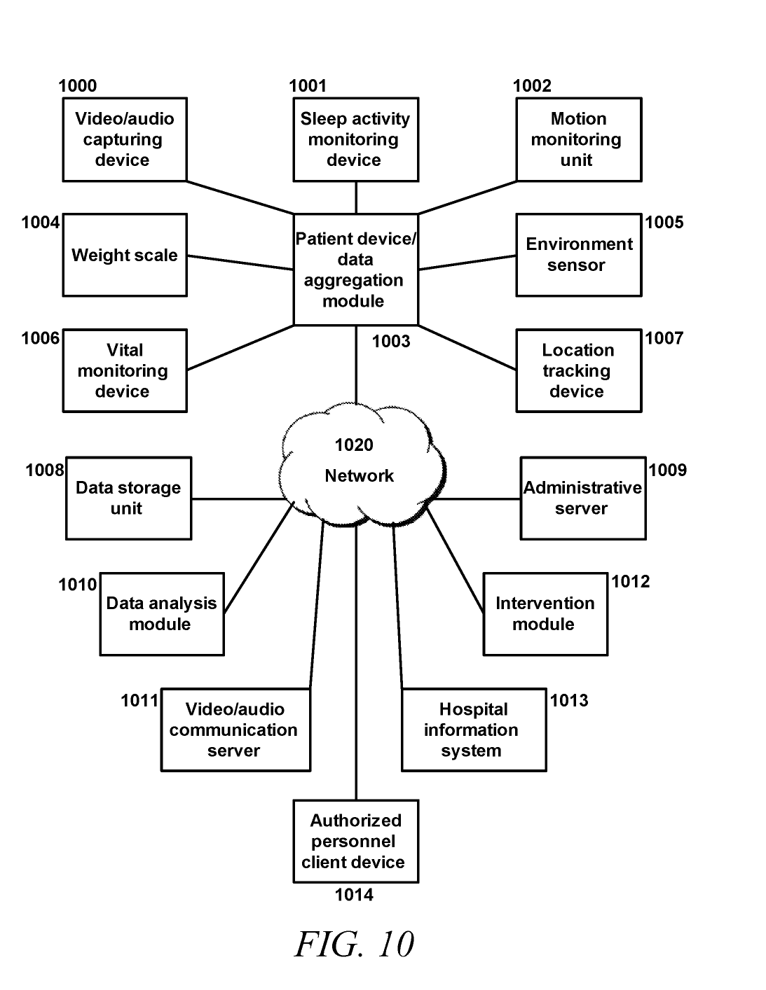

FIG. 10 illustrates an exemplary embodiment showing a schematic diagram of the system for patient behavior and health monitoring. The patient's behavior data and physical state may be acquired by the plurality of behavior monitoring devices: a video/audio capturing device 1000, a sleep activity monitoring device 1001, and a motion monitoring unit 1002. In addition, a location tracking device 1007, an environment sensor 1005, a weight scale 1004, and the vital monitoring device 1006 may be presented. In this embodiment, the patient device may comprise the data aggregation module 1003 to gather acquired data from each of the devices monitoring the patient. The components of the system may be in communication with one another via the network 1020. In some embodiments, certain stand-alone sensors may also be utilized to gather more data from the patient, such as the weight scale 1004. The acquired data may be monitored by the designated Health Care Provider (HCP), such as the authorize personnel, with the authorized personnel client device 1014. The data storage unit 1008 may store the acquired data over time. The hospital information system 1013 may further provide the patient's medical history to the data storage unit 1008. The data analysis module 1010 may provide the multi-parametric analysis of the acquired data. The authorized personnel may issue an intervention via the intervention module 1012 based on the analysis. Additional administrative duties such as system maintenance may be governed separately at the administrative server 1009. In addition, the system may comprise the video/audio communication server 1011 to facilitate a communication between the patient and the authorized personnel each using their client devices.

The following exemplary embodiments provides a detailed data flow of the system for patient behavior and health monitoring. The exemplary embodiments below provides exemplary system network environments.

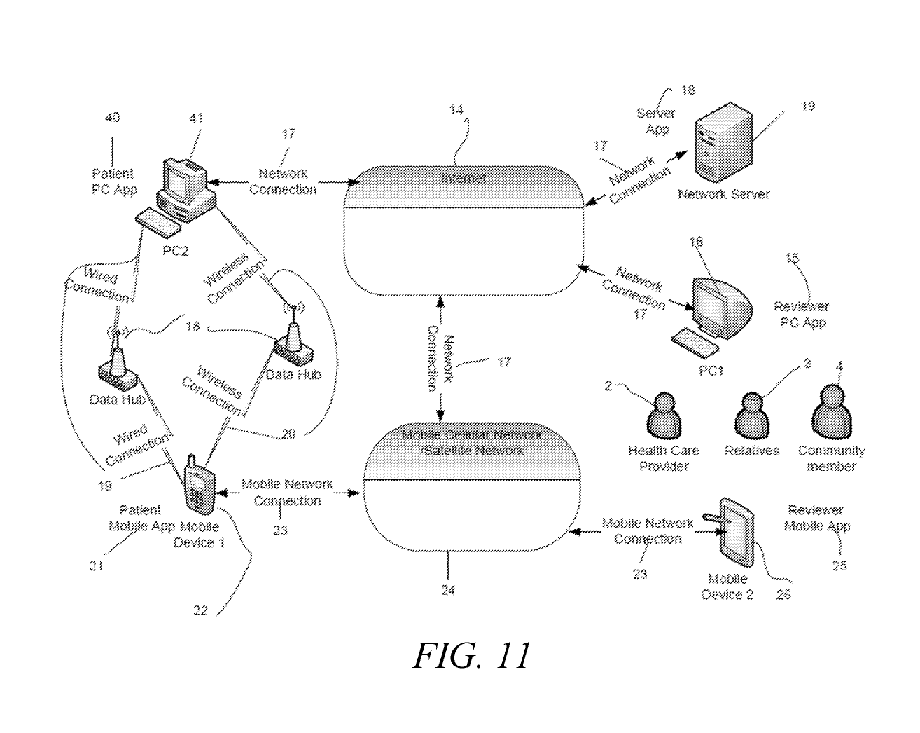

FIG. 11 illustrates how data flow among components of the system interact with one another. The sensor data may be communicated by the data hub 18 from medical device 12, such as patient health monitoring sensors, to the patient Mobile App 21 (the patient's client device) that may run on a mobile computing device 21. The patient mobile App 21 stores the measured data in its data storage unit on the mobile computing device 22 together with the patient generated data and data captured by camera in communication with the mobile computing device 22. The complete data or selected/summarized data in the data storage unit could be sent by the Patient Mobile App 21 to reviewer App 25 (the authorized personnel's client device). The reviewer mobile App 25 may store the received data on its database resides on mobile computing device 26. An input received by the reviewer mobile App 25 could go back to Mobile App 21 in the reversed path. The selected data could be synced up with network server 19 by passing mobile network connection 23 in mobile cellular network/satellite network 24 to network connection 17 of Internet 14. The reviewer mobile App 25 could sync its database with network server 19 by using mobile network connection 23 in mobile cellular network/satellite network 24 and network connection 17 of Internet 14. Similarly, Patient health monitoring data collected by data hub 18 from patient health monitoring sensors 12 may be transmitted to the patient PC App 40 running on a PC 41. Patient PC App 40 could sync all or selected data to network server 19 by using network connection 17 or Internet 14. Once data is on the network server 19, the reviewer PC app 15 could sync its database with network server 19 by using network connection 17 on Internet 14,

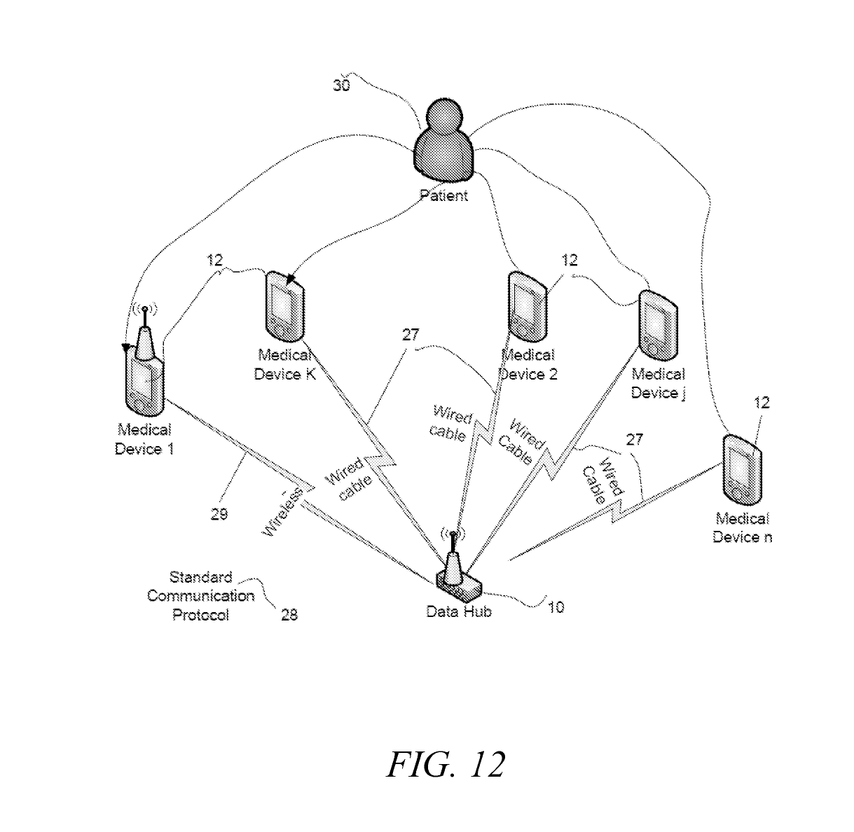

FIG. 12 illustrates an exemplary data acquisition system. The data acquisition system 30 may comprise data hub 10 connected to a plurality of medical devices (e.g. a plurality of sensors) 12 by wired cable 27 and/or wireless channel 29. The data hub 10 may be connected to mobile computing device 22 and/or PC 41 by wired connection 19 or wireless connection 20. Standard communication protocol 28 may be used to enable data exchange between data hub 10 and medical devices 12. The data hub 10 could be standalone or integrated to mobile computing device 22 or PC 41. Any medical device in comply with communication protocol 28 can plug into the system and the data can be collected by data hub 10. The wired cable 27 could be industry stand cable such as USB cable or RS232 cable or smart cable that may incorporate special function such as a cable with Apple iOS authentication process. The medical devices contemplated herein may be the behavior monitoring device, the vital monitoring device, and any other medical devices known in the art.

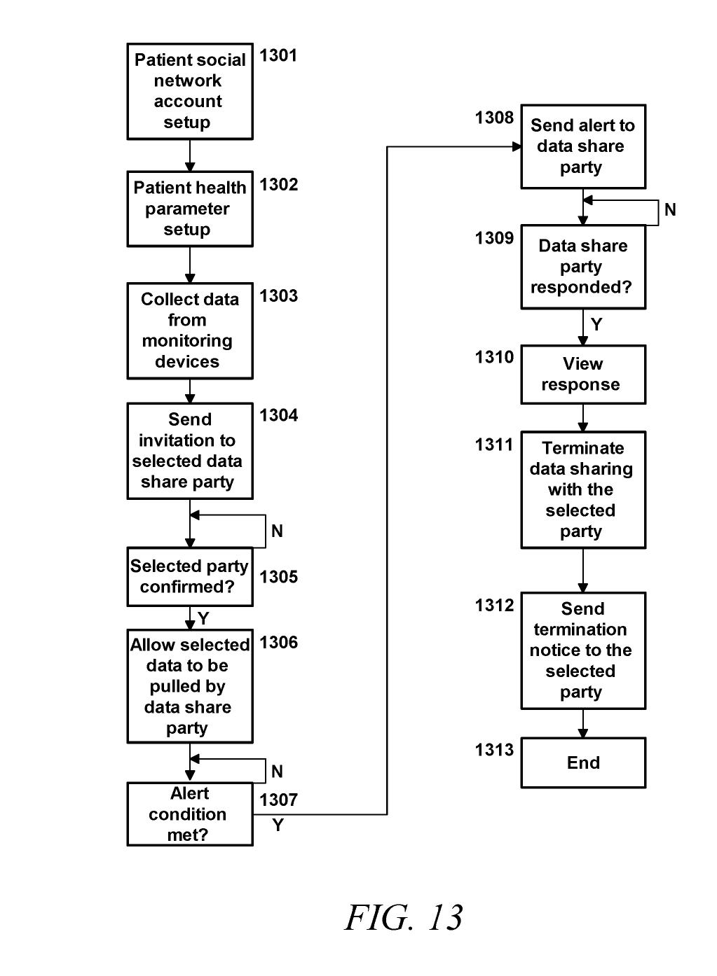

FIG. 13 illustrates an exemplary flowchart describing a human validation process for the patient's health condition assessment. The embodiment is related to patient alarm and emergency state monitoring and servicing. FIG. 13 relates to how a patient alert is shared among the authorized personnel and other relevant people such as family, friends and network community member. Step 1301 is for a patient to register himself or herself with the network server. Then in step 1302 the patient sets up the medical and health data that could be relevant to the authorized personnel. For example, a prior medical history or the initial state of the patient may be provided here. Then the data collection begins at 1303. Invitations that include collected data from 1303 may be presented to the authorized personnel or other people to be the reviewer and receiver of the acquired data from the monitoring devices described above 1304. Once the request is confirmed 1305, the acquired data may be provided to the authorized personnel's client device at 1306. When an alert condition is met based on the acquired data analyzed by the multi-parametric analysis module 1307, alarm and/or emergency may be issued to the data share party 1308 (the authorized personnel) in real time by voice call, txt message or email, and the like. At step 1309, the authorized personnel may respond to the alarm issued. The authorized personnel may review the patient's health condition and alarm issued by the multi-parametric analysis module at 1310. At this step, the authorized personnel may take an appropriate action, such as sending an intervention or assessing the patient's health condition. At step 1311, the acquired data and the alert state may be terminated. A notice of termination may be sent to the data share party at 1312.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the art will readily observe that numerous modifications, applications and alterations of the device and method may be made while retaining the teachings of the present invention.

What is claimed is:

1. A system using a behavior monitoring device and a vital monitoring device, with one or more processors and a memory, in communication with a data storage unit via a network, for monitoring a patient's health condition, comprising:
the behavior monitoring device providing a behavior data of the patient acquired by monitoring a physical activity of the patient, the behavior monitoring device being positioned to monitor the patient, the behavior data being stored in the data storage unit;
the vital monitoring device providing a physical state of the patient acquired by measuring a vital sign of the patient, the vital monitoring device being operatively coupled to the patient, the physical state being stored in the data storage unit;
a data aggregation module, in communication with the one or more processors, receiving the behavior data and the physical state from the behavior monitoring device and the vital monitoring device, respectively; and
a multi-parametric analysis module, in communication with the one or more processors, configured to:
compare the behavior data with a model reference, the model reference providing an expected behavior data, the model reference being stored in the data storage unit; and
assess the patient's health condition by collectively analyzing the compared behavior data, the physical state, and a correlation between the behavior data and the physical state, wherein the patient's health condition indicates a diagnosis of the patient.

2. The system of claim 1 further comprising an intervention module, in communication with the one or more processors, providing an intervention to the patient via a computerized user interface, wherein the intervention is determined based on the assessed patient's health condition and a human validation response received from an authorized personnel reviewing the assessed patient's health condition, the intervention is selected from the group consisting of the diagnosis, a message, an instruction, and an alert.

3. The system of claim 1 wherein the behavior monitoring device tracks a movement of the patient, the behavior monitoring device identifying an amount and a frequency of the movement.

4. The system of claim 1 wherein the behavior monitoring device tracks a sleep activity of the patient, the behavior monitoring device identifying a motion during sleep, a duration of sleep, and a frequency of the motion during sleep.

5. The system of claim 1 wherein the behavior monitoring device is a camera recording the physical activity of the patient, the physical activity comprising at least one of:
a facial activity;
a gait;
a skin tone; and
a body language.

6. The system of claim 1 wherein the behavior monitoring device records sound provided by the patient, the behavior monitoring device acquiring a speech pattern of the patient.

7. The system of claim 1 wherein the behavior monitoring device is an odor sensor, the behavior monitoring device identifying a type of an odor detected by the odor sensor.

8. The system of claim 1 further comprising an environment sensor, wherein the environment sensor measures environmental condition surrounding the patient, the multi-parametric analysis module assessing the patient's health condition by collectively analyzing the environmental condition, the behavior data, the physical state, and a correlation among the environmental condition, the behavior data, and the physical state.

9. The system of claim 1 further comprising a client device, wherein the behavior monitoring device monitors an interaction between the patient and the client device, the client device providing an instruction for the patient to interact with the client device, the behavior data further comprising the interaction.

10. The system of claim 1 wherein a type of the vital monitoring device is selected, from a plurality of vital monitoring device types, based on a comparison between an instant record and a past record of the behavior data and the physical state, the behavior data and the physical state being stored in the data storage unit over time.

11. A computer implemented method to use a system that uses a behavior monitoring device and a vital monitoring device, with one or more processors and a memory, in communication with a data storage unit via a network, for monitoring a patient's health condition, the method comprising:
identifying a behavior data of the patient, with the behavior monitoring device, acquired by monitoring a physical activity of the patient, the behavior monitoring device being positioned to monitor the patient, the behavior data being stored in the data storage unit;
identifying a physical state of the patient, with the vital monitoring device, acquired by measuring a vital sign of the patient, the vital monitoring device being operatively coupled to the patient, the physical state being stored in the data storage unit;
aggregating the behavior data and the physical state of the patient, with a data aggregation module in communication with the one or more processors;
comparing, with a multi-parametric analysis module in communication with the one or more processors, the behavior data with a model reference, the model reference providing an expected behavior data, the model reference being stored in the data storage unit; and
assessing, with the multi-parametric analysis module, the patient's health condition by collectively analyzing the compared behavior data, the physical state, and a correlation between the behavior data and the physical state, wherein the patient's health condition indicates a diagnosis of the patient.

12. The method of claim 11 further comprising the step of providing an intervention, with an intervention module in communication with the one or more processors, to the patient via a computerized user interface, wherein the intervention is determined based on the assessed patient's health condition and a human validation response received from an authorized personnel reviewing the assessed patient's health condition, the intervention is selected from the group consisting of the diagnosis, a message, an instruction, and an alert.

13. The method of claim 11 wherein the behavior data is identified by tracking a movement of the patient, the behavior monitoring device identifying an amount and a frequency of the movement.

14. The method of claim 11 wherein the behavior data is identified by tracking a sleep activity of the patient, the behavior monitoring device identifying a motion during sleep, a duration of sleep, and a frequency of the motion during sleep.

15. The method of claim 11 wherein the behavior monitoring device is a camera, the behavior data being identified by recording the physical activity of the patient, the physical activity comprising at least one of:
a facial activity;
a gait;
a skin tone; and
a body language.

16. The method of claim 11 wherein the behavior data is identified by recording sound provided by the patient, the behavior monitoring device acquiring a speech pattern of the patient.

17. The method of claim 11 wherein the behavior monitoring device is an odor sensor, the behavior data is identified by identifying a type of an odor detected by the odor sensor.

18. The method of claim 11 further comprising the step of identifying an environmental condition surrounding the patient with an environment sensor, wherein the patient's health condition is further assessed, with the multi-parametric analysis module, by collectively analyzing the environmental condition, the behavior data, the physical state, and a correlation among the environmental condition, the behavior data, and the physical state.

19. The method of claim 11 wherein the behavior data is identified by monitoring an interaction between the patient and a client device, the client device providing an instruction for the patient to interact with the client device, the behavior data further comprising the interaction.

20. The method of claim 11 further comprising the steps of:
comparing an instant record and a past record of the behavior data and the physical state, the behavior data and the physical state being stored in the data storage unit over time; and
selecting a type of the vital monitoring device from a plurality of vital monitoring device types based on the comparison.
